(19) United States
(12) Patent Application Publication
(10) Pub. No.: US 2023/0298101 A1
(43) Pub. Date: Sep. 21, 2023

(54) SYSTEMS AND METHODS FOR QUANTUM COMPUTING-ASSISTED PORTFOLIO SELECTION

(71) Applicant: JPMORGAN CHASE BANK, N.A., New York, NY (US)

(72) Inventors: Akshay AJAGEKAR, Ithaca, NY (US); Pierre MINSSEN, New York, NY (US); Romina YALOVETZKY, New York, NY (US); Marco PISTOIA, Amawalk, NY (US)

(21) Appl. No.: 17/653,258

(22) Filed: Mar. 2, 2022

(51) Int. Cl. G06Q 40/06; G06N 10/60; G06N 10/80

(52) U.S. Cl. CPC G06Q 40/06; G06N 10/60; G06N 10/80

(57) ABSTRACT

A method for quantum computing-assisted portfolio selection may include a classical computer program: (1) receiving a plurality of asset selection parameters for an asset portfolio; (2) initializing a current selection of assets from a plurality of available assets; (3) setting a risk upper bound value to a risk upper bound initial value, and a risk lower bound value to a risk lower bound initial value; (4) instructing a quantum computer to solve a first sub-problem; (5) calculating an objective functional value; (6) setting the risk upper bound value to the objective functional value; (7) instructing the quantum computer to determine a new selection of assets by solving a second sub-problem using a second quantum algorithm; and (8) returning an optimal portfolio selection.

### BACKGROUND OF THE INVENTION

### 1. Field of the Invention

Embodiments relate generally to systems and methods for quantum computing-assisted portfolio selection.

### 2. Description of the Related Art

Portfolio selection deals with the selection of a number of assets that optimize risk or expected return subject to operational constraints. It is an essential use case in finance, but its computational complexity forces financial institutions to resort to approximated solutions, which take a long time to complete and often lead to inaccurate results. For this reason, the scientific community has started to investigate how to use Quantum Computing to address the problem of portfolio optimization efficiently and accurately. Nevertheless, the large number of constraints and assets are a challenge for this solution development as well as the requirement of handling both inequality and equality constraints.

### SUMMARY OF THE INVENTION

Systems and methods for quantum computing-assisted portfolio selection are disclosed. According to one embodiment, a method for quantum computing-assisted portfolio selection may include: (1) receiving, by a classical computer program executed by a classical computer, a plurality of asset selection parameters for an asset portfolio; (2) initializing, by the classical computer program, a current selection of assets from a plurality of available assets; (3) setting, by the classical computer program, a risk upper bound value to a risk upper bound initial value, and a risk lower bound value to a risk lower bound initial value; (4) instructing, by the classical computer program, a quantum computer to solve a first sub-problem; (5) calculating, by the classical computer program, an objective functional value; (6) setting, by the classical computer program, the risk upper bound value to the objective functional value; (7) instructing, by the classical computer program, the quantum computer to determine a new selection of assets by solving a second sub-problem using a second quantum algorithm; and (8) returning, by the classical computer program, an optimal portfolio selection.

In one embodiment, the method may further include determining an objective function that identifies a minimum amount of risk for the current selection of assets using a first quantum algorithm.

In one embodiment, calculating the objective functional value comprises using the objective function and a transaction cost for the current selection of assets.

In one embodiment, the method may further include updating, by the classical computer program, the risk lower bound value based on the risk upper bound value and a difference between a transaction cost between the current selection of assets and the new selection of assets.

In one embodiment, the method may further include creating, by the classical computer program, a constraint Hamiltonian by adding an integer cut to exclude a subset of the current selection of assets from the constraint Hamiltonian.

In one embodiment, the first quantum algorithm comprises the Harrow-Hassidim-Lloyd (HHL) quantum algorithm or the Variational Quantum Linear Solver (VQLS) quantum algorithm and the second quantum algorithm comprises binary optimization or the Quantum Approximate Optimization Algorithm (QAOA).

In one embodiment, the quantum computer comprises a universal quantum computer or quantum annealing hardware.

In one embodiment, the risk upper bound initial value is set to infinity, and a risk lower bound initial value is set to negative infinity.

In one embodiment, the quantum computer solves the second sub-problem by minimizing a constraint Hamiltonian.

According to another embodiment, a system may include a classical computer comprising a memory storing a classical computer program and a computer processor and a quantum computer in communication with the classical computer. The classical computer program receives a plurality of asset selection parameters for an asset portfolio; initializes a current selection of assets from a plurality of available assets; sets a risk upper bound value to a risk upper bound initial value, and a risk lower bound value to a risk lower bound initial value; instructs a quantum computer to solve a first sub-problem; calculates an objective functional value; sets the risk upper bound value to the objective functional value; instructs the quantum computer to determine a new selection of assets by solving a second sub-problem using a second quantum algorithm; and returns an optimal portfolio selection.

In one embodiment, the classical computer program determines an objective function that identifies a minimum amount of risk for the current selection of assets using a first quantum algorithm.

In one embodiment, the classical computer program calculates the objective functional value, the objective function, and a transaction cost for the current selection of assets.

In one embodiment, the classical computer program updates the risk lower bound value based on the risk upper bound value and a difference between a transaction cost between the current selection of assets and the new selection of assets.

In one embodiment, the classical computer program creates a constraint Hamiltonian by adding an integer cut to exclude a subset of the current selection of assets from the constraint Hamiltonian.

In one embodiment, the quantum computer solves the first sub-problem using the Harrow-Hassidim-Lloyd (HHL) quantum algorithm or the Variational Quantum Linear Solver (VQLS) quantum algorithm, and the second quantum algorithm comprises binary optimization or the Quantum Approximate Optimization Algorithm (QAOA).

In one embodiment, the classical computer program selects a quantum computer to execute the first quantum algorithm, wherein the quantum computer comprises a universal quantum computer or quantum annealing hardware.

In one embodiment, the risk upper bound initial value is set to infinity, and a risk lower bound initial value is set to negative infinity.

In one embodiment, the quantum computer solves the second sub-problem by minimizing a constraint Hamiltonian.

According to another embodiment, an electronic device may include a memory storing a classical computer program and a computer processor. When executed by the computer processor, the classical computer program causes the computer processor to: receive a plurality of asset selection parameters for an asset portfolio; initialize a current selection of assets from a plurality of available assets; set a risk upper bound value to a risk upper bound initial value, and a risk lower bound value to a risk lower bound initial value; instruct a quantum computer to solve a first sub-problem; calculate an objective functional value; set the risk upper bound value to the objective functional value; instruct the quantum computer to determine a new selection of assets by solving a second sub-problem using a second quantum algorithm; and return an optimal portfolio selection.

In one embodiment, the classical computer program selects a quantum computer to solve the first sub-problem using a first quantum algorithm, wherein the quantum computer comprises a universal quantum computer or quantum annealing hardware, and the first quantum algorithm comprises the Harrow-Hassidim-Lloyd (HHL) quantum algorithm or the Variational Quantum Linear Solver (VQLS) quantum algorithm, and the second quantum algorithm comprises binary optimization or the Quantum Approximate Optimization Algorithm (QAOA).

According to another embodiment, a method for quantum computing-assisted portfolio selection may include: (1) receiving, by a classical computer program executed by a classical computer, a plurality of asset selection parameters for an asset portfolio; (2) initializing, by the classical computer program, a current selection of assets from a plurality of available assets; (3) setting, by the classical computer program, a risk upper bound value to a risk upper bound initial value, and a risk lower bound value to a risk lower bound initial value; (4) instructing, by the classical computer program, a quantum computer to solve a first sub-problem to determine an objective function that identifies a minimum amount of risk for the current selection of assets using a first quantum algorithm; (5) calculating, by the classical computer program, an objective functional value using the objective function and a transaction cost for the current selection of assets; (6) setting, by the classical computer program, the risk upper bound value to the objective functional value; (7) instructing, by the classical computer program, the quantum computer to determine a new selection of assets by solving a second sub-problem using a second quantum algorithm; (8) updating, by the classical computer program, the risk lower bound value based on the risk upper bound value and a difference between a transaction cost between the current selection of assets and the new selection of assets; and (9) returning, by the classical computer program, an optimal portfolio selection.

In one embodiment, the method may also include creating, by the classical computer program, a constraint Hamiltonian by adding an integer cut to exclude a subset of the current selection of assets from the constraint Hamiltonian.

In one embodiment, the current selection of assets may satisfy a cardinality constraint.

In one embodiment, the first quantum algorithm may include the Harrow-Hassidim-Lloyd (HHL) quantum algorithm or the Variational Quantum Linear Solver (VQLS) quantum algorithm.

In one embodiment, the quantum computer may include a universal quantum computer or quantum annealing hardware.

In one embodiment, the second quantum algorithm may include binary optimization or the Quantum Approximate Optimization Algorithm (QAOA).

In one embodiment, the risk upper bound initial value may be set to infinity, and a risk lower bound initial value is set to negative infinity.

In one embodiment, the quantum computer may solve the second sub-problem by minimizing a constraint Hamiltonian.

According to another embodiment, a system may include a classical computer comprising a memory storing a classical computer program and a computer processor, and a quantum computer in communication with the classical computer. The classical computer program may receive a plurality of asset selection parameters for an asset portfolio; may initialize a current selection of assets from a plurality of available assets; may set a risk upper bound value to a risk upper bound initial value, and a risk lower bound value to a risk lower bound initial value; may instruct the quantum computer to solve a first sub-problem to determine an objective function that identifies a minimum amount of risk for the current selection of assets using a first quantum algorithm; may calculate an objective functional value using the objective function and a transaction cost for the current selection of assets; may set the risk upper bound value to the objective functional value; may instruct the quantum computer to determine a new selection of assets by solving a second sub-problem using a second quantum algorithm; may update the risk lower bound value based on the risk upper bound value and a difference between a transaction cost between the current selection of assets and the new selection of assets; and may return an optimal portfolio selection.

In one embodiment, the classical computer program may create a constraint Hamiltonian by adding an integer cut to exclude a subset of the current selection of assets from the constraint Hamiltonian.

In one embodiment, the current selection of assets may satisfy a cardinality constraint.

In one embodiment, the quantum computer may solve the first sub-problem using the Harrow-Hassidim-Lloyd (HHL) quantum algorithm or the Variational Quantum Linear Solver (VQLS) quantum algorithm.

In one embodiment, the classical computer program may select a quantum computer to execute the first quantum algorithm, wherein the quantum computer comprises a universal quantum computer or quantum annealing hardware.

In one embodiment, the second quantum algorithm may comprise binary optimization or the Quantum Approximate Optimization Algorithm (QAOA).

In one embodiment, the risk upper bound initial value may be set to infinity, and a risk lower bound initial value may be set to negative infinity.

In one embodiment, the quantum computer may solve the second sub-problem by minimizing a constraint Hamiltonian. For the constraint Hamiltonian which is a quadratic function of variables, there exists a combination of variables for which the function assumes the least value. Minimizing refers to identifying this combination of variables that produce the smallest value for the constraint Hamiltonian.

According to another embodiment, an electronic device may include a memory storing a classical computer program and a computer processor. When executed by the computer processor, the classical computer program causes the computer processor to: receive a plurality of asset selection parameters for an asset portfolio; initialize a current selection of assets from a plurality of available assets; set a risk upper bound value to a risk upper bound initial value, and a risk lower bound value to a risk lower bound initial value; instruct a quantum computer to solve a first sub-problem to determine an objective function that identifies a minimum amount of risk for the current selection of assets using a first quantum algorithm; calculate an objective functional value using the objective function and a transaction cost for the current selection of assets; set the risk upper bound value to the objective functional value; instruct the quantum computer to determine a new selection of assets by solving a second sub-problem using a second quantum algorithm; update the risk lower bound value based on the risk upper bound value and a difference between a transaction cost between the current selection of assets and the new selection of assets; and return an optimal portfolio selection.

In one embodiment, the classical computer program may create a constraint Hamiltonian by adding an integer cut to exclude a subset of the current selection of assets from the constraint Hamiltonian.

In one embodiment, the classical computer program may select a quantum computer to solve the first sub-problem using a first quantum algorithm. The quantum computer may include a universal quantum computer or quantum annealing hardware, and the first quantum algorithm may include the Harrow-Hassidim-Lloyd (HHL) quantum algorithm or the Variational Quantum Linear Solver (VQLS) quantum algorithm

In one embodiment, the second quantum algorithm may include binary optimization or the Quantum Approximate Optimization Algorithm (QAOA).

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a system for quantum computing-assisted portfolio selection according to one embodiment;

FIG. 2 depicts a method for quantum computing-assisted portfolio selection according to one embodiment.

### DETAILED DESCRIPTION OF PREFERRED EMBODIMENTS

Embodiments are directed to systems and methods for quantum computing-assisted asset portfolio selection. For example, embodiments may optimize the selection of assets (e.g., investment assets such as securities) that are in an asset portfolio. The optimal portfolio selection may be based on a selection of assets that optimize risk or expected return subject to operational constraints.

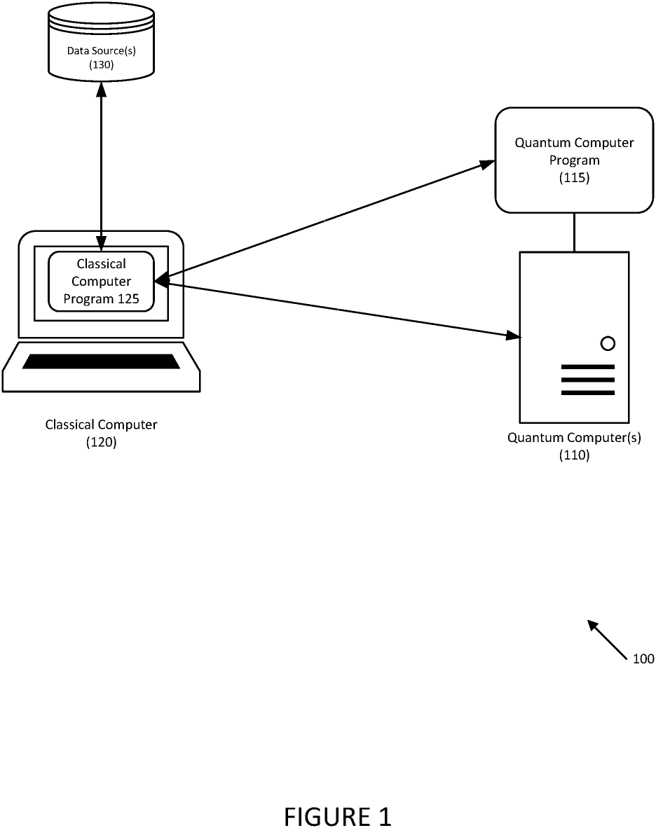

Referring to FIG. 1, a system for quantum computing-assisted asset portfolio selection is disclosed according to an embodiment. System 100 may include quantum computer 110 that may execute quantum computer program 115. Classical computer 120 may interface with quantum computer program 115 using classical computer program 125. Classical computer 120 may be any suitable classical computing device, including servers, workstations, desktop, notebook, laptop, or tablet computers, etc.

A plurality of quantum computers 110 may be used. For example, one quantum computer may be a universal quantum computer that may execute a Quantum Approximate Optimization Algorithm (QAOA), and another quantum computer may be quantum annealing hardware to execute a quantum annealing algorithm. In one embodiment, quantum computer program 115 may be an algorithm, such as QAOA or quantum annealing.

An example of QAOA is given in Farhi, E., Goldstone, J. & Gutmann, S. (2014) “A quantum approximate optimization algorithm,” arXiv preprint arXiv:1411.4028, the disclosure of which is incorporated, by reference, in its entirety.

An example of Quantum Annealing is given in Farhi, E., Goldstone, J., Gutmann, S., & Sipser, M. (2000) “Quantum computation by adiabatic evolution,” arXiv preprint quant-ph/0001106., the disclosure of which is incorporated, by reference, in its entirety.

Other algorithms may be used as is necessary and/or desired.

In one embodiment, the universal quantum computer and/or the quantum annealing hardware may be used.

Classical computer program 125 may provide input to, and receive output from, one or more quantum computers 110 and/or quantum computer program 115. In one embodiment, classical computer program 125 may generate one or more quantum computer programs 115, such as one or more quantum circuits, and may provide one or more quantum computer programs 115 to quantum computer 110. Classical computer program 125 may receive the results of the execution of the one or more quantum computer programs 115.

Data source(s) 130 may include one or more sources of data. For example, data source(s) 130 may provide input data such as data for the asset portfolio to be optimized, the expected returns of assets, the historical prices of the assets, the overall expected return, the trading cost of each asset, the total cost expected to be incurred, and the total budget to invest. Other data may be provided as is necessary and/or desired.

In one embodiment, classical computer program 125 may create one or more quantum circuits that implements at least portions of subproblems. Classical computer program 125 may then transpile the quantum circuit(s) and may then send the transpiled circuit(s) to the quantum computer for execution. Classical computer program 125 may receive the results from quantum computer(s) 110.

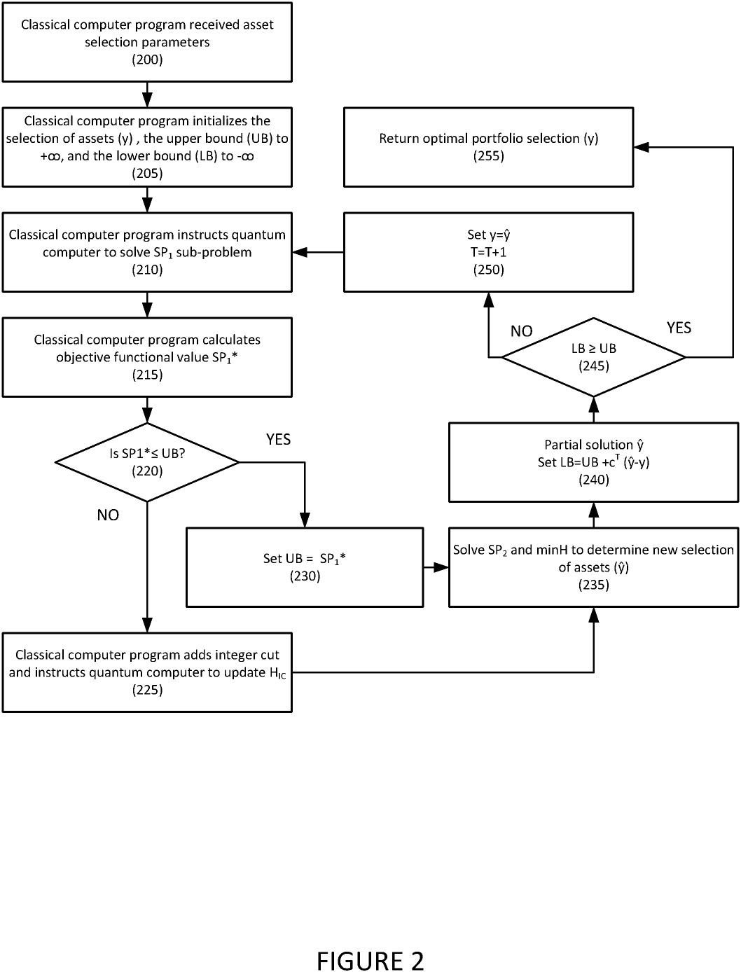

Referring to FIG. 2, a method for quantum computing-assisted asset portfolio selection is disclosed according to an embodiment. In step 200, the classical computer may receive asset selection parameters. In one embodiment, the asset selection parameters may include the available assets (i) in a universe of assets (A), expected returns, a covariance matrix (∑) of historical closing prices for all assets in the universe of assets, an expected return for each asset (µ), a proportion of assets needed in the portfolio, cost transaction (c), and a level of expected return (R), a maximum number of assets in the portfolio (K), a maximum allowable total transaction cost (Tc), an upper bound on the proportion of capital invested in each asset (u), and a lower bound on the proportion of capital invested in each asset (l).

A scaling factor (M) may be computed such that:

$$M ≫ {max}_{i , j ∈ A , j \neq i} {\text{Σ}}_{i j} .$$

In step 205, a classical computer program may initialize a selection of assets (y) and may set a risk upper bound (UB) initial value to infinity (oo), and a risk lower bound (LB) initial value to negative infinity (-oo). For example, for the first iteration, the minimum risk is negative infinity, and the maximum risk is positive infinity. Embodiments update these bounds until the lower bound is greater than or equal to the upper bound.

In embodiments, y is a binary vector (e.g., γ = (y₁, y₂, y₃, .., yₙ)). Each element of the vector indicates whether each asset should be included in the optimal portfolio or not. For example, given a portfolio with 5 assets, y could be (1, 0, 0, 1, 1). This means that the first and the last two assets are included in the “optimal” portfolio.

The initial section of assets may be random, may be received as parameters, etc.

In the first iteration, embodiments start with a first selection of assets y and then this selection of assets is updated. For example, there may be 5 assets initially selected, and embodiments may iteratively determine that only 3 of the 5 should be included in the optimal portfolio.

In step 210, the classical computer program may instruct one of a plurality of quantum computers to solve a first of two sub-problems, SP₁, to optimize the asset portfolio using the parameters received. SP₁ is as follows:

$$\begin{matrix}min {x}^{T} \text{Σ} x \\ s . t . {\sum }_{i ∈ A} {x}_{i} = 1 \\ {\sum }_{i ∈ A} {μ}_{i} {x}_{i} \geq R \\ {l}_{i} {y}_{i} \leq {x}_{i} \leq {u}_{i} {y}_{i} ∀ i ∈ A \\ {x}_{i} ∈ ℝ ∀ i ∈ A\end{matrix}$$

The quantum computer program returns an objective function, min SP₁(y), which represents the minimum amount of risk for assets y. The term “min” represents the goal of minimization, and SP₁(y)) indicates the function dependent on parameters (y).

In step 215, using min SP₁(y), the classical computer program may calculate the objective functional value SP₁*:

$$S {P}_{1} {}^{∗} = {c}^{T} y + m i n S {P}_{1} \left(y\right)$$

where c is the transaction cost and T is a counter. For example, if a faction of an asset is bought, a transaction cost is required to be paid. SP₁*is used to see whether to add integer cuts and update H_{IC}, below.

Since the cardinality constraint (i.e., the maximum number of assets that are to be selected in the optimal portfolio) is always satisfied, the risk upper bound (UB) value will decrease with each iteration unless the SP₁ sub-problem is infeasible. If in step 220, SP₁* is not less than or equal to the risk upper bound (which means that SP₁ is infeasible - the assets considered in this problem should not be considered for the optimal portfolio), in step 225, the classical computer program may add an integer cut and update H_{IC}, the constraint Hamiltonian. The constraint Hamiltonian represents the quadratic unconstrained binary form of the constraints in the optimization problem.

The integer cut excludes the selected combination of assets in the portfolio and can be represented by set S:

$${\sum }_{i ∈ S} {y}_{i} \leq \left|S\right| - 1 , S ≡ \left\{i \left|{y}_{i} = 1\right)\right\}$$

These integer cuts may be further formulated into a Quadratic Unconstrained Binary Optimization (QUBO) problem as shown in the following equation with an empirically determined scaling factor s₂:

$${H}_{I C} = {s}_{2} \left(2 {\sum }_{i , j ∈ S , j > i} {y}_{i} {y}_{j} + \left|S\right| {\sum }_{i ∈ S} {y}_{i}\right)$$

If SP₁* is less than or equal to the risk upper bound, in step 230, the risk upper bound may be set to SP₁*.

In step 235, the quantum computer may solve a second sub-problem SP₂ and minH. To solve SP₂ on a quantum computer, the classical computer may construct the constraint Hamiltonian (H) and minimize it. Solving minH produces a solution to SP₂.

H_{SP2} may be pre-defined for a given optimization problem and is constructed using the parameters of the problem. In the absence of an integer cut, H = H_{SP2}. If an integer cut is required, H = H_{SP2} + H_{IC}. ŷ is the optimal solution of minH.

Embodiments may use the following equation to solve SP₂:

$$\begin{matrix}S {P}_{2} \left(x\right) : \\ min z \\ s . t . z \geq {x}^{T} \text{Σ} x + M {\sum }_{i ∈ A} {c}_{i} {y}_{i} \\ {\sum }_{i ∈ A} {y}_{i} \leq K \\ {y}_{i} ∈ \left\{0 , 1\right\} ∀ i ∈ A\end{matrix}$$

The quantum computer may then determine a new selection of assets, ŷ, by solving min H = H_{SP2} + H_{IC}, by, for example, quantum annealing or QAOA, where ŷᵢ, ∀ᵢ∈A. First, H_{SP2} is calculated as follows:

$${H}_{S {P}_{2}} = M {\sum }_{i ∈ A} {c}_{i} {y}_{i} + {s}_{1} \left(\left(1 - K\right) {\sum }_{i ∈ A} {y}_{i} + 2 {\sum }_{i , j ∈ A , j > i} {y}_{i} {y}_{j}\right)$$

Then, using the value H_{IC} calculated above, min H may be solved.

For example, the classical computer program may select one of a plurality of quantum algorithms to use (e.g., binary optimization performed on quantum annealers or Quantum Approximate Optimization Algorithm (QAOA) implemented on circuit model quantum computers) to solve the SP₂ sub-problem, and may send the SP₂ sub-problem to the appropriate quantum computer.

In one embodiment, the same quantum computer may be used to solve both the SP₁ and SP₂ sub-problems, or may use different quantum computers.

In step 240, the classical computer program may receive the new selection of assets ŷ and may update the risk lower bound (LB) to equal the risk upper bound + _{C}^{T} (ŷ-y), which represents the current risk upper bound and the difference between transaction costs (e.g., the security trading cost for each asset) incurred with current and updated selection of assets.

In step 245, if the risk lower bound is not greater than or equal to the risk upper bound, in step 250, the classical computer program may set y= ŷ and T to T+1. It may then return to step 210 and iterate using the new value T.

If the risk lower bound is greater than or equal to risk upper bound, in step 255. the classical computer program may return the optimal portfolio selection, y. This means that the assets in vector y (out of the A assets) should be included in the optimal portfolio. Using assets y as an input to the SP₁ sub-problem, the classical computer program will yield the amount of each of the assets to invest in.

For example, the classical computer program may select one of a plurality of quantum algorithms to solve the SP₁ sub-problem. For example, the SP₁ sub-problem may be solved with the Harrow-Hassidim-Lloyd (HHL) quantum algorithm, the Variational Quantum Linear Solver (VQLS) quantum algorithm, or any others suitable quantum linear solving algorithm. The classical computer program may also select one of a plurality of quantum computers (e.g., a universal quantum computer, quantum annealing hardware, etc.) depending on the quantum algorithm selected.

An example of HHL is given in Harrow, A. W., Hassidim, A., & Lloyd, S. (2009). “Quantum algorithm for linear systems of equations” Physical review letters, 103(15), 150502, the disclosure of which is incorporated by reference in its entirety.

An example of VQLS is given in Bravo-Prieto, C., LaRose, R., Cerezo, M., Subasi, Y., Cincio, L., & Coles, P. J. (2019). “Variational quantum linear solver” arXiv preprint arXiv:1909.0582, the disclosure of which is incorporated by reference in its entirety.

In one embodiment, the SP₁ sub-problem may be solved with classical linear solvers if problem size is too large (e.g., over one hundred assets).

Although several embodiments have been disclosed, it should be recognized that these embodiments are not exclusive to each other, and certain elements or features from one embodiment may be used with another.

Hereinafter, general aspects of implementation of the systems and methods of the invention will be described.

The system of the invention or portions of the system of the invention may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

In one embodiment, the processing machine may be a classical computer, a quantum computer, etc.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further embodiment of the invention, be performed by a single component. Further, the processing performed by one distinct component as described above may be performed by two distinct components. In a similar manner, the memory storage performed by two distinct memory portions as described above may, in accordance with a further embodiment of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity; i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of paper, paper transparencies, a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, a memory stick, or other remote transmission, as well as any other medium or source of data that may be read by the processors of the invention.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for quantum computing-assisted portfolio selection, comprising:
receiving, by a classical computer program executed by a classical computer, a plurality of asset selection parameters for an asset portfolio;
initializing, by the classical computer program, a current selection of assets from a plurality of available assets;
setting, by the classical computer program, a risk upper bound value to a risk upper bound initial value, and a risk lower bound value to a risk lower bound initial value;
instructing, by the classical computer program, a quantum computer to solve a first sub-problem;
calculating, by the classical computer program, an objective functional value;
setting, by the classical computer program, the risk upper bound value to the objective functional value;
instructing, by the classical computer program, the quantum computer to determine a new selection of assets by solving a second sub-problem using a second quantum algorithm; and
returning, by the classical computer program, an optimal portfolio selection.

2. The method of claim 1, further comprising:
determining an objective function that identifies a minimum amount of risk for the current selection of assets using a first quantum algorithm.

3. The method of claim 2, wherein calculating the objective functional value comprises using the objective function and a transaction cost for the current selection of assets.

4. The method of claim 1, further comprising:
updating, by the classical computer program, the risk lower bound value based on the risk upper bound value and a difference between a transaction cost between the current selection of assets and the new selection of assets.

5. The method of claim 1, further comprising:
creating, by the classical computer program, a constraint Hamiltonian by adding an integer cut to exclude a subset of the current selection of assets from the constraint Hamiltonian.

6. The method of claim 1, wherein the first quantum algorithm comprises the Harrow-Hassidim-Lloyd (HHL) quantum algorithm or the Variational Quantum Linear Solver (VQLS) quantum algorithm and the second quantum algorithm comprises binary optimization or the Quantum Approximate Optimization Algorithm (QAOA).

7. The method of claim 1, wherein the quantum computer comprises a universal quantum computer or quantum annealing hardware.

8. The method of claim 1, wherein the risk upper bound initial value is set to infinity, and a risk lower bound initial value is set to negative infinity.

9. The method of claim 1, wherein the quantum computer solves the second sub-problem by minimizing a constraint Hamiltonian.

10. A system, comprising:
a classical computer comprising a memory storing a classical computer program and a computer processor; and
a quantum computer in communication with the classical computer;
wherein the classical computer program receives a plurality of asset selection parameters for an asset portfolio; initializes a current selection of assets from a plurality of available assets; sets a risk upper bound value to a risk upper bound initial value, and a risk lower bound value to a risk lower bound initial value; instructs a quantum computer to solve a first sub-problem; calculates an objective functional value; sets the risk upper bound value to the objective functional value; instructs the quantum computer to determine a new selection of assets by solving a second sub-problem using a second quantum algorithm; and returns an optimal portfolio selection.

11. The system of claim 10, wherein the classical computer program determines an objective function that identifies a minimum amount of risk for the current selection of assets using a first quantum algorithm.

12. The system of claim 10, wherein the classical computer program calculates the objective functional value, the objective function, and a transaction cost for the current selection of assets.

13. The system of claim 10, wherein the classical computer program updates the risk lower bound value based on the risk upper bound value and a difference between a transaction cost between the current selection of assets and the new selection of assets.

14. The system of claim 10, wherein the classical computer program creates a constraint Hamiltonian by adding an integer cut to exclude a subset of the current selection of assets from the constraint Hamiltonian.

15. The system of claim 10, wherein the quantum computer solves the first sub-problem using the Harrow-Hassidim-Lloyd (HHL) quantum algorithm or the Variational Quantum Linear Solver (VQLS) quantum algorithm, and the second quantum algorithm comprises binary optimization or the Quantum Approximate Optimization Algorithm (QAOA).

16. The system of claim 11, wherein the classical computer program selects a quantum computer to execute the first quantum algorithm, wherein the quantum computer comprises a universal quantum computer or quantum annealing hardware.

17. The system of claim 11, wherein the risk upper bound initial value is set to infinity, and a risk lower bound initial value is set to negative infinity.

18. The system of claim 11, wherein the quantum computer solves the second sub-problem by minimizing a constraint Hamiltonian.

19. An electronic device, comprising:
a memory storing a classical computer program; and
a computer processor;
wherein, when executed by the computer processor, the classical computer program causes the computer processor to:
receive a plurality of asset selection parameters for an asset portfolio;
initialize a current selection of assets from a plurality of available assets;
set a risk upper bound value to a risk upper bound initial value, and
a risk lower bound value to a risk lower bound initial value;
instruct a quantum computer to solve a first sub-problem;
calculate an objective functional value;
set the risk upper bound value to the objective functional value;
instruct the quantum computer to determine a new selection of assets by solving a second sub-problem using a second quantum algorithm; and
return an optimal portfolio selection.

20. The electronic device of claim 19, wherein the classical computer program selects a quantum computer to solve the first sub-problem using a first quantum algorithm, wherein the quantum computer comprises a universal quantum computer or quantum annealing hardware, and the first quantum algorithm comprises the Harrow-Hassidim-Lloyd (HHL) quantum algorithm or the Variational Quantum Linear Solver (VQLS) quantum algorithm, and the second quantum algorithm comprises binary optimization or the Quantum Approximate Optimization Algorithm (QAOA).
